(19) United States
(12) Patent Application Publication
(10) Pub. No.: US 2009/0286067 A1
(43) Pub. Date: Nov. 19, 2009

(54) FRICTION MATERIAL

(75) Inventors: Katsuhiro KIKUCHI, Tokyo (JP); Motoki KUROE, Tokyo (JP); Hiroshi IDEI, Tokyo (JP)

Correspondence Address: DRINKER BIDDLE & REATH (DC), 1500 K STREET, N.W., SUITE 1100, WASHINGTON, DC, 20005-1209, US

(73) Assignee: AKEBONO BRAKE INDUSTRY CO., LTD., Tokyo (JP)

(21) Appl. No.: 12/463,587

(22) Filed: May 11, 2009

(30) Foreign Application Priority Data
May 12, 2008 (JP) P.2008-124792

(51) Int. Cl. B32B 5/30; B32B 18/00

(52) U.S. Cl. 428/325; 428/454

(57) ABSTRACT

A friction material contains substantially no material whose Mohs hardness is higher than 6. In addition, the friction material contains a layered clay mineral, in which titania particles are inserted into layers, at a rate of 0.5%-by-mass to 20%-by-mass.

### BACKGROUND OF THE INVENTION

1. Field of the Invention

The present invention relates to a friction material and, more particularly, to a friction material capable of maintaining a necessary friction coefficient, restraining the grinding of a mating member, and preventing a generation of vibrations due to a deformation of the mating member and a contamination of wheels due to wear powders of the mating member.

2. Background Art

A non-asbestos based friction material used in a brake pad of an automobile or the like is made as follows. That is, in a base material comprising, e.g., metal fibers such as steel fibers and copper fibers, inorganic fibers such as ceramic fibers and carbon fibers, organic fibers such as aramid fibers, a lubricant such as graphite, antimony trisulfide or molybdenum disulfide, a filler such as a swelling clay mineral, barium sulfate, calcium carbonate, or calcium hydroxide, and a friction modifier, e.g., cashew dust, oxide-based ceramic powder such as silica, alumina, and zirconia, metal powder, or the like are mixed. In addition, a binder resin (binder), such as a phenolic resin or an epoxy resin, is mixed with these ingredients. Then, this mixture is sufficiently agitated. Subsequently, compression molding is performed on this mixture while this mixture is heated.

However, in the case of a friction material containing a hard material such as the aforementioned oxide-based ceramic powder, a mating member is grounded while friction braking is performed. Consequently, there is a fear of occurrence of problems of a generation of vibrations due to a deformation of the grounded mating member and a contamination of wheels due to wear powders of the mating member.

Thus, in order to solve such problems, according to, e.g., JP-A-2005-336340, a friction material is caused to contain an elastomer. Thus, improvement of performance of the friction material under low speed and low load conditions is achieved. However, due to recent speeding-up and function-enhancement of automobiles, loads on brakes are increased. Accordingly, further improvement of performance of a friction material is required.

### SUMMARY OF THE INVENTION

According to one or more embodiments of the invention, there is provided a friction material capable of maintaining a necessary friction coefficient, restraining a grinding of a mating member, and preventing a generation of vibrations due to a deformation of a mating member and a contamination of wheels due to wear powders of the mating member.

In accordance with one or more embodiments of the invention, a friction material contains substantially no material whose Mohs hardness is higher than 6. In addition, the friction material contains, at a rate of 0.5%-by-mass to 20%-by-mass, a layered clay mineral, in which titania particles are inserted into layers.

The average particle size of the titania particles inserted into the layers of the layered clay mineral, in which the titania particles are inserted into the layers, may range from 3 nm to 200 nm.

The content of the titania particles inserted into the layers of the layered clay mineral, in which the titania particles are inserted into the layers, may range from 10%-by-mass to 80%-by-mass.

The layered clay mineral, in which the titania particles are inserted into the layers, may be made by burning a layered clay mineral, in which a titania precursor formed by a sol-gel method is intercalated into the layers, at a temperature of 500° C. or higher.

According to one or more embodiments of the invention, there is provided a friction material capable of maintaining a necessary friction coefficient, restraining the grinding of a mating member, and preventing the generation of vibrations due to the deformation of the mating member and the contamination of wheels due to the wear powders of the mating member.

Other aspects and advantages of the invention will be apparent from the following description of exemplary embodiments and examples and the appended claims.

### DETAILED DESCRIPTION OF THE EXEMPLARY EMBODIMENTS

A friction material according to an exemplary embodiment of the invention contains substantially no material whose Mohs hardness is higher than 6. In addition, the friction material contains, at a rate of 0.5%-by-mass to 20%-by-mass, a layered clay mineral, in which titania particles are inserted into layers.

In the present invention, the requirement that “a friction material contains substantially no material whose Mohs hardness is higher than 6” should be interpreted that a hard material having a Mohs hardness higher than 6 to be inevitably inserted thereinto is allowable. More specifically, according to the exemplary embodiment of the invention, the friction material can contain a hard material having a Mohs hardness higher than 6 at a rate of 0.0 to 0.5%-by-mass.

For example, silica (7), alumina (9), zirconia (7), and dichrome trioxide (8) can be cited as the hard material having a Mohs hardness higher than 6. Incidentally, each parenthetic numerical value designates a Mohs hardness. Preferably, the Mohs hardness of the hard material which the friction material does not contain substantially is 7 or higher.

As long as the friction material contains substantially no material whose Mohs hardness is higher than 6, the friction material can restrain a grinding of a mating member, and can prevent a generation of vibrations due to the deformation of a mating member and a contamination of wheels due to wear powders of the mating member.

Incidentally, the aforementioned Mohs hardness of a material is determined by a method of using ten standard minerals selected as described below, and trying to scratch the material with minerals sequentially selected in the ascending order of hardness from the ten standard ones, and then determining the level of hardness of the standard mineral, which is lower by one level than that of hardness of the standard mineral that can make a scratch on the surface of the material, as the Mohs hardness of the material. The levels of hardness and the standard minerals respectively associated with those of hardness thereof are arranged in the ascending order of hardness as follows: 1. talc, 2. gypsum, 3. calcite, 4. fluorite, 5. apatite, 6. feldspar, 7. quartz, 8. topaz, 9. corundum, and 10. diamond.

The friction material according to the invention contains a layered clay mineral (hereinafter abbreviated as a “titania particle insertion clay mineral”), in which titania particles are inserted into the layers, in order to restrain reduction in the friction coefficient, which is caused due to the fact that the friction material contains substantially no material whose Mohs hardness is higher than 6, to thereby maintain a necessary friction coefficient.

### <Titania Particle Insertion Clay Mineral>

According to the exemplary embodiment of the invention, there is no particular limitation to a preparing method for a titania particle insertion clay mineral contained in the friction material. For example, a titania particle insertion clay mineral can be obtained by burning a layered clay mineral, in which a titania precursor formed by a sol-gel method is intercalated into layers, at a temperature of 500° C. or higher.

### (1. Layered Clay Mineral)

Natural clay minerals and synthetic clay minerals, which are phyllosilicate minerals each having a layered structure and have cation exchange ability, can be cited as the layered clay mineral that is used as one of raw materials of the titania particle insertion clay mineral according to the invention. More specifically, the layered clay mineral is, e.g., kaolinite, smectite, vermiculite, mica, brittle mica, and chlorite. Montmorillonite, saponite, bidellite, nontronite, and the like are cited as the smectites. In addition, synthetic fluorine mica obtained by fluorinating mica can be used. This synthetic fluorine mica is suitable for the layered clay mineral, because variation in quality thereof is small. Sodium fluor-tetrasilicic mica (NaMg_{2.5}Si₄O₁₀F₂) can be exemplified as the synthetic fluorine mica.

According to the exemplary embodiment of the invention, either a single type of such a layered clay mineral or a combination of two types or more of such layered clay minerals can be used.

### (2. Manufacture of Titania Particle Insertion Clay Mineral)

The titania particle insertion clay mineral can be obtained by performing the step (a) of intercalating, in an aqueous medium, a titania precursor formed by a sol-gel method into layers of a layered clay mineral, and the step (b) of performing, after the step (a), water wash of a solid material obtained by solid-liquid separation and then burning the solid material at a temperature of 500° C. or higher.

### (2-1. Step (a))

This step (a) is a step of intercalating, in an aqueous medium, a titania precursor formed by a sol-gel method into layers of the aforementioned layered clay mineral.

In this step (a), for example, the following method can be employed as a method of intercalating the titania precursor, which is formed by the sol-gel method, into the layers of the layered clay mineral.

First, the aqueous medium and the layered clay mineral are mixed together to thereby cause the clay mineral to take in interlayer water. Thus, a sol configured to maximally spread an interlayer gap is formed.

On the other hand, a hydrolysable titanium compound is added to an aqueous solution of an organic acid having an appropriate concentration. The titanium compound is subjected to a hydrolysis process and a condensation reaction at a temperature of about 20° C. to 70° C. for a time of about 5 minutes to 240 minutes. Thus, a titania precursor sol is formed. At that time, the organic acid is used to stabilize the titania precursor sol. For example, calboxylic acids, such as an acetic acid, an oxalic acid, and a formic acid, can be cited as the organic acid.

Subsequently, the sol of the layered clay mineral and that of the titania precursor are mixed together. This mixture is usually held for a time of about 10 minutes to 300 minutes at a temperature ranging from about room temperature to about 100° C. Thus, the interlayer water taken in the clay mineral is substituted for the titania precursor sol, so that the titania precursor is sandwiched between the layers of the layers of the clay mineral and then intercalated.

### <Hydrolysable Titanium Compound>

For example, a compound represented by the following general formula (I) can be employed as the hydrolysable titanium compound used to form the titania precursor sol:

R³ₙTiX₄₋ₙ (1)

(in this formula, “R³” designates a non-hydrolysable group, and “X” denotes a hydrolysable group or a hydroxyl group, and “n” represents an integer ranging from 0 to 3; in a case where there are a plurality of non-hydrolysable groups R³, the plurality of non-hydrolysable groups R³ can be either the same as one another or different from one another; and in a case where there are a plurality of Xs, the Xs can be either the same as one another or different from one another).

A hydrocarbon group which may have a functional group can be cited as the non-hydrolysable group represented by R³ in the aforementioned general formula (1). Straight-chain-like or branched-chain-like alkyl groups, alkenyl groups, cycloalkyl groups, and aryl groups or aralkyl groups can be cited as the aforementioned hydrocarbon groups.

An alkyl group and an alkenyl group, each of which preferably has a carbon number of 1 to 25, more preferably, 1 to 3, are desirable. A cycloalkyl group preferably having a carbon number of 3 to 25, more preferably, 3 to 6, is desirable. An aryl group preferably having a carbon number of 6 to 25, more preferably, 6 to 10, is desirable. An aralkyl group preferably having a carbon number of 7 to 25, more preferably, 7 to 10, is desirable.

For example, an ester bond, an ether bond, an epoxy group, an amino group, a carboxy group, a carbonyl group, an amido group, a mercapto group, a sulphonyl group, a cyano group, a hydroxyl group, and halogen atoms can be cited as a functional group that can be introduced into the hydrocarbon group.

An alkoxy group, an alkenyloxy group, a ketoxime group, an acyloxy group, halogen atoms and the like can be cited as the hydrolysable group of X in the general formula (I). In the formula (I), “n” designates an integer ranging from 0 to 3, preferably, 0 to 2, more preferably, an integer 0 or 1.

For example, the following compounds can be cited as a desirable hydrolysable titanium compound represented by the aforementioned general formula (1). That is, tetraethoxytitanium, tetra-n-propoxytitanium, tetraisopropoxytitanium, tetra-n-butoxytitanium, tetraisobutoxytitanium, tetra-sec-butoxytitanium, tetra-tert-butoxytitanium, tetra-acetoxytitanium, methyltriethoxytitanium, vinyltriethoxytitanium, phenyltriethoxytitanium, methyltri-n-propoxytitanium, vinyltri-n-propoxytitanium, methyltriisopropoxytitanium, vinyltriisopropoxytitanium, phenyltriisopropoxytitanium, and the like can be cited. Either a single type of such a hydrolysable titanium compound or a combination of two types or more of such hydrolysable titanium compounds can be used.

### (2-2. Step (b))

This step (b) is a step of performing, after the step (a) is performed, solid-liquid separation using conventionally known means, such as centrifugal separation and filtration, and next performing sufficient water wash of a resultant solid material, and then burning the solid material at a temperature of 500° C. or higher.

Preferably from the viewpoint of removing unreacted alkoxy group and hydroxyl group of the titania precursor, the burning temperature in the step (b) is 500° C. or higher. More preferably, the burning temperature ranges from 500° C. to 900° C. Thus, a titania particle insertion clay mineral can be obtained by burning the solid material. The size of titania particles can be adjusted to a desired particle size by crushing this titania particle insertion clay mineral and classifying resultant particles.

### (3. Properties of Titania Particle Insertion Clay Mineral)

According to the exemplary embodiment of the invention, preferably, the average particle size of titania particles inserted into the layers of the titania particle insertion clay mineral is within a range of 3 nm to 200 nm, more preferably, 3 nm to 50 nm, from the view point of enlarging an interlayer of the clay mineral.

Incidentally, the values of the aforementioned average particle size are measured by the following method.

Method of Measuring Average Particle Size of Titanium Particles of Titania Particle Insertion Clay Mineral

The titania particle size was measured from an image observed using a scanning transmission electron microscope (STEM) “Science” (manufactured by HITACHI, Ltd.) at an accelerating voltage of 200 kV. An observation test sample was processed using focused ion beams (FIB) such that the thickness thereof ranged from 80 nm to 100 nm.

From the viewpoint of uniformly inserting titania particles into the layers of the titania particle insertion clay mineral, preferably, the content of the titania particles of the clay mineral ranges from 10%-by-mass to 80%-by-mass, more preferably, 30%-by-mass to 60%-by-mass.

The values of the aforementioned content of the titania particles were obtained by being calculated from an amount of the layered clay mineral and that of the hydrolysable titanium compound, which were used to make the clay mineral.

### <Materials for Forming Friction Material>

According to the exemplary embodiment of the invention, a friction material can be obtained by performing molding according to an ordinary method using materials for forming the friction material, which include a binder resin, the aforementioned titania particle insertion clay mineral, a fibrous reinforcement material, a lubricant, a friction modifier, an additional filler and the like.

According to the exemplary embodiment of the invention, it is necessary that the aforementioned lubricant, the friction modifier, and the additional filler and the like of the materials for forming the friction material include substantially no hard material having a Mohs hardness of higher than 6.

### (1. Binder Resin)

There is no particular limitation to the binder resin in the materials for forming the friction material. An optional one can appropriately be used by being selected from thermosetting resins, e.g., a phenol resin, an epoxy resin, and a polybenzoxazine, which have been known as a binder resin in the materials for forming the friction material.

### (2. Fibrous Reinforcement Material)

Any of organic fibers and inorganic fibers can be used as the fibrous reinforcement material in the materials for forming the friction material. High-strength aromatic polyamide fibers (aramid fibers: a trade name “Kevlar” (registered trademark) manufactured by E.I. DuPont de Nemours Inc.), flame-resistant acrylic fibers, polyimide fibers, poly-acrylate fibers, and polyester fibers, and the like can be cited as the organic fibers. On the other hand, ceramic fibers such as alumina-silica fibers, and metal fibers such as stainless steel fibers, copper fibers, brass fibers, nickel fivers, iron fibers, and the like can be cited as the inorganic fibers, in addition to potassium titanate fibers, basalt fibers, silicon carbide fibers, glass fibers, carbon fibers, and Wollastonite. Either a single type of such a fibrous material or a combination of two types or more of such fibrous materials can be used.

### (3. Lubricant Material, Friction Modifier, and Additional Filler)

There is no particular limitation to the lubricant material in the materials for forming the friction material. An optional one can appropriately be used by being selected from known materials which have hitherto been used as lubricant materials in the friction materials. Graphite, graphite fluoride, carbon black, metal sulfides such as a tin sulfide and a tungsten disulfide, polytetrafluoroethylene (PTFE), boron nitride, and the like can be cited as practical examples of this lubricant material. Either a single type of such a lubricant material or a combination of two types or more of such lubricant materials can be used.

There is no particular limitation to the friction modifier in the materials for forming the friction material. An optional one can appropriately be used by being selected from known materials which have hitherto been used as friction modifiers in the friction materials. Inorganic friction modifiers, e.g., metal oxides such as a magnesia and an iron oxide, a zirconium silicate, a silicon carbide, metal powder such as copper powder, brass powder, zinc powder, and iron powder, titanate powder, and the like, and organic friction modifiers, i.e., nitrile-butadiene rubber (NBR), styrene butadiene rubber (SBR), rubber dust such as tire tread rubber, and organic dust such as cashew dust, and the like can be cited as practical examples of this friction modifier. Either a single type of such a friction modifier or a combination of two types or more of such friction modifiers can be used.

The materials for forming the friction material can contain swelling clay minerals as the additional fillers in addition to the reinforcement material and the friction modifier. For example, a kaolin, a talc, a smectite, a vermiculite, and a mica can be cited as the swelling clay minerals.

In addition, the materials for forming the friction material can contain calcium carbonate, barium sulfate, calcium hydroxide, and the like.

According to the exemplary embodiment of the invention, in a composite material, a filler treated with an organic compound can be used as an inorganic filler, among the lubricant material, the friction modifier, and the additional filler, in order to improve the dispersibility of the filler in the composite material.

For example, materials such as a calcium carbonate, a barium sulfate, magnesia, aluminum powder, copper powder, zinc powder, graphite, a tin sulfide, a tungsten disulfide, or the like, treated with an organic compound, can be cited in addition to the swelling clay mineral as the filler treated with an organic compound.

The swelling clay mineral has a layered structure. As an intercalation compound is formed by treating the clay mineral with an organic compound, interlayer spacing is increased, so that layer peeling easily occurs. Thus, the dispersibility of the filler into the composite material according to the invention can be enhanced.

Amines, quaternary ammonium salts and the like can be cited as the organic compound to be used to treat the swelling clay mineral. For example, an aliphatic amine and an aromatic amine, each of which has a carbon number of 1 to 18, can be used as the amines. Hydrochloride salts, oxalates, and the like of diethylamine, amylamine, dodecylamine, stearylamine, di-dodecylamine can be cited as practical examples of the aliphatic amine. Aniline, toluidine, xylidine, phenylenediamine, and the like can be cited as the practical examples of the aromatic amines. Among these amines, specifically, aniline is preferred. On the other hand, e.g., dimethyldioctadecyl-ammonium chloride, and oleyl bis-(2-hydroxyethyl) methyl ammonium chloride can be cited as preferred quaternary ammonium salts.

Preferably, treatment of fillers other than the swelling clay mineral, e.g., fillers such as a calcium carbonate, a barium sulfate, magnesia, aluminum powder, copper powder, zinc powder, graphite, a tin sulfide, a tungsten disulfide, or the like, with an organic compound is performed using aliphatic or aromatic primary amines, each of which has a carbon number of 10 to 35 or so, or a silane coupling agent having a terminal primary amine group as the organic compound.

For example, n-dodecylamine, n-hexadecylamine, n-octadecylamine, n-nonadecylamine, p-tert-butylaniline, p-octylaniline, and p-dodecylaniline are cited as the aliphatic or aromatic primary amines. For instance, 3-aminopropyltrimethoxysilane, and 3-aminopropyltriethoxysilane are cited as the silane coupling agent. Among these compounds, n-dodecylamine is particularly preferred.

There is no particular limitation to the method of treating the filler with the organic compound. A method of treating the filler using the organic compound in a molten state as it is, or a method of dissolving the organic compound into an appropriate organic solvent and treating the filler in a solution state can be employed as the method of treating the filler with the organic compound.

There is no particular limitation to the method of causing the composite material to contain the filler treated with the organic compound. A method of melting and kneading the filler together with other ingredients can be employed. Alternatively, from the viewpoint of enhancing the dispersibility of the filler, a method of mixing the filler into the composite material in a process of making the binder resin can be employed.

### <Preparation of Friction Material>

According to the exemplary embodiment of the invention, in order to prepare a friction material, the aforementioned material for making the friction material is filled into a mold. Then, performing thereof is performed thereon at room temperature under a pressure of 5 MPa to 30 MPa or so. Subsequently, heating and compression-molding are performed thereon for a time of 5 minutes to 35 minutes on conditions that the temperature ranges from 130° C. to 19.0° C. or so, and that the pressure ranges 10 MPa to 100 MPa or so. Then, if needed, heat treatment is performed thereon at a temperature of 160° C. to 270° C. or so for a time of 1 hour to 10 hours or so. Thus, a desired friction material can be prepared.

The prepared friction material can maintain a necessary friction coefficient, and can restrain the grinding of a mating member used while friction braking is performed. Thus, the friction material can prevent the generation of vibrations due to the deformation of the mating member and the contamination of wheels due to wear powders of the mating member.

### EXAMPLES

Next, the invention is described in more detail below with reference to examples. However, the invention is not limited to these examples.

### Preparation Example 1

First, 10 g of synthetic fluorine mica “ME-10” manufactured by CO-OP CHEMICAL CO. LTD., which was a layered clay mineral, were put into 1000 g of distilled water which was an aqueous medium. Then, the synthetic fluorine mica was swelled and dispersed at room temperature for a time of 24 hours by being agitated. Thus, synthetic fluorine mica liquor was prepared.

On the other hand, 19 g (0.2 mol) of tetrapropoxytitanium was put into 340 g of an acetic acid aqueous solution in which the percent-by-mass concentration of acetic acid was 80%-by-mass. Subsequently, an agitation and a mixing of tetrapropoxytitanium were performed at a temperature of 60° C. for 1 hour. Then, this mixture was cooled to 25° C. This mixture was mixed with the aforementioned synthetic fluorine mica liquor and agitated at a temperature of 25° C. for 3 hours.

Subsequently, the solid-liquid separation of this liquid mixture was performed by centrifugal separation to thereby extract solid content. Then, water wash and centrifugal separation were repeated using distilled water until the pH of wash liquid exceeded 5. Next, the obtained solid content was burnt at a temperature of 600° C. for 72 hours. Thus, 15 g of a synthetic fluorine mica (hereunder referred to as a TiO₂-containing fluorine mica A), in which titania particles were inserted into layers, were obtained.

The average particle size of the titania particles contained in the TiO₂-containing fluorine mica A was found to be about 5 nm, as a result of being measured by the method described in the text of the present specification. The content of the titania particles contained in the TiO₂-containing fluorine mica A was 35%-by-mass.

### Preparation Example 2

Similarly to Preparation Example 1, excepting that the amount of tetrapropoxytitanium was changed to 52 g (0.56 mol) and that the burning temperature was changed to 800° C., 24 g of a synthetic mica (hereunder referred to as TiO₂-containing fluorine mica B), in which titania particles were inserted into layers, were obtained.

The average particle size of the titania particles contained in the TiO₂-containing fluorine mica B was found to be about 15 nm, as a result of being measured by the method described in the text of the present specification. The content of the titania particles contained in the TiO₂-containing fluorine mica B was 60%-by-mass.

### Examples 1 and 2 and Comparative Examples 1 and 2

Materials for forming a friction material, which have compounding compositions described in Table 1, were prepared. Friction material test pieces, each of which was shaped like a plate that was 13 mm in longitudinal length, 35 mm in transverse length and 10 mm in thickness, were made under the following conditions.

### <Conditions for Making Materials for Friction Material>

Ingredients of each composition described in Table 1 were dispensed so that the mass of each composition was 1 kg. Then, the ingredients of each composition were mixed together using a 10-liter Irich mixer. Subsequently, thermoforming was performed on this mixture at 150° C. under a pressure of 30 MPa for 10 minutes. In addition, this mixture was heat-treated at 250° C. for 3 hours. Thus, a friction material plate which was 65 mm in longitudinal length, 50 mm in transverse length, and 10 mm in thickness was made. Then, a cutting process was performed on this plate to thereby make a friction material test piece.

Subsequently, the following wear test was performed on each of the friction material test pieces to measure a wear amount (μm) of the mating member and a wear amount (mm) and the average friction coefficient of the friction material. Table 1 shows results.

### <Wear Test>

The wear amount (μm) of the mating member and a wear amount (mm) and the average friction coefficient of the friction material were measured using a wear tester of the model named “INERTIAL TYPE (1/10)-SCALE TESTER” manufactured by Akebono engineering corporation under the following conditions:

Mating member: FC250

Braking Initial Speed: 100 km/h

Braking Deceleration: 5.88 m/s²

The Number of Times of Braking: 20

Braking Temperatures: 200° C., and 500° C.

TABLE 1

| | | | | | Comparative | Comparative |
|---|---|---|---|---|---|---|
| | | | Example 1 | Example 2 | Example 1 | Example 2 |
| Compounding | phenolic resin¹⁾ | | 15 | 15 | 15 | 15 |
| Composition | resin dust²⁾ | | 7 | 7 | 7 | 7 |
| (%-by-mass) | barium sulfate³⁾ | | 34 | 31 | 34 | 39 |
| | dichrome trioxide⁴⁾ | | 0 | 0 | 5 | 0 |
| | phosphorous | | 4 | 4 | 4 | 4 |
| | graphite⁵⁾ | | | | | |
| | aramid pulp | | 10 | 10 | 10 | 10 |
| | steel fiber | | 15 | 15 | 15 | 15 |
| | metal powder⁶⁾ | | 10 | 10 | 10 | 10 |
| | fluorine mica A | | 5 | 0 | 0 | 0 |
| | containing TiO₂ | | | | | |
| | fluorine mica B | | 0 | 8 | 0 | 0 |
| | containing TiO₂ | | | | | |
| | total | | 100 | 100 | 100 | 100 |
| Wear Test | Wear Amount of | | 9.4 | 14.1 | 43.1 | −4.3 |
| | Mating member | | | | | (transfer) |
| | [500° C.] (μm) | | | | | |
| | Wear Amount of | | 1.1 | 1.3 | 2.7 | 4.7 |
| | Friction Material | | | | | |
| | [500° C.] (mm) | | | | | |
| | Friction | 200° C. | 0.37 | 0.36 | 0.41 | 0.21 |
| | Coefficient | 500° C. | 0.35 | 0.37 | 0.38 | 0.23 |

[Notes]
¹⁾phenolic resin: trade name “Y-2235” manufactured by Cashew Co., Ltd.
²⁾resin dust: trade name “D-5” manufactured by Cashew Co., Ltd.
³⁾barium sulfate: Mohs hardness is 3
⁴⁾dichrome trioxide: Mohs hardness is 8
⁵⁾phosphorous graphite: trade name “CD-150” manufactured by Nippon graphite industries, ltd.
⁶⁾metal powder: copper powder, Mohs hardness is 3

As is understood from Table 1, in the case of Examples 1 and 2 which include fluorine mica containing TiO₂ and no dichrome trioxide whose Mohs hardness is about 8, the wear amount of each mating member is small. In addition, the friction coefficient of each of Examples 1 and 2 is stable.

On the other hand, in the case of Comparative Example 1 which includes dichrome trioxide, whose Mohs hardness is about 8, and no fluorine mica containing TiO₂, the wear amount of each mating member is large. In addition, in Comparative Example 2 which does not contain dichrome trioxide and TiO₂-containing fluorine mica, the wear amount of friction material is large, the transfer to the mating member is recognized and the friction coefficient is low.

While description has been made in connection with the exemplary embodiments and specific examples of the invention, it will be obvious to those skilled in the art that various changes and modification may be made therein without departing from the present invention. It is aimed, therefore, to cover in the appended claims all such changes and modifications falling within the true spirit and scope of the present invention.

What is claimed is:

1. A friction material containing substantially no material whose Mohs hardness is higher than 6, and said friction material contains, at a rate of 0.5%-by-mass to 20%-by-mass, a layered clay mineral in which titania particles are inserted into layers of the layered clay.

2. The friction material according to claim 1, wherein an average particle size of said titania particles inserted into said layers of said layered clay mineral in which said titania particles are inserted into said layers ranges from 3 nm to 200 nm.

3. The friction material according to claim 1, wherein a content of said titania particles inserted into said layers of said layered clay mineral in which said titania particles are inserted into said layers ranges from 10%-by-mass to 80%-by-mass.

4. The friction material according to claim 1, wherein said layered clay mineral in which said titania particles are inserted into said layers is obtained by burning, at a temperature of 500° C. or higher, a layered clay mineral in which a titania precursor formed by a sol-gel method is intercalated into layers.

5. A friction material containing substantially no material whose Mohs hardness is higher than 6, and said friction material contains, at a rate of 0.5%-by-mass to 20%-by-mass, a layered clay mineral in which titania particles are inserted into layers of the layered clay,
wherein an average particle size of said titania particles inserted into said layers of said layered clay mineral in which said titania particles are inserted into said layers ranges from 3 nm to 200 nm,
wherein a content of said titania particles inserted into said layers of said layered clay mineral in which said titania particles are inserted into said layers ranges from 10%-by-mass to 80%-by-mass, and
wherein said layered clay mineral in which said titania particles are inserted into said layers is obtained by burning, at a temperature of 500° C. or higher, a layered clay mineral in which a titania precursor formed by a sol-gel method is intercalated into layers.
